(19) United States
(12) Patent Application Publication
(10) Pub. No.: US 2003/0189015 A1
(43) Pub. Date: Oct. 9, 2003

(54) Device for screening/sieving a liquid loaded with bulk material, and procedure for screening/sieving such a liquid

(76) Inventor: Roumen Kaltchev, Montagnole (FR)

Correspondence Address: BURR & BROWN, PO BOX 7068, SYRACUSE, NY, 13261-7068, US

(21) Appl. No.: 10/400,596

(22) Filed: Mar. 27, 2003

(30) Foreign Application Priority Data
Apr. 8, 2002 (FR) 02.04345

(51) Int. Cl. B01D 29/62

(52) U.S. Cl. 210/791; 210/159; 210/413

(57) ABSTRACT

The invention relates to a screening/sieving device for waste waters. The device according to the invention is mainly suitable for a plant in a channel. It serves to separate particles whose size exceeds a few millimetres, from the waste water. The device according to the invention consists of a frame, inside which bars are stretched at some distance from each other. Cleaning is carried out by a “comb” which slides between the bars and which deposits the waste onto a second comb located outside the frame.

### TECHNICAL FIELD

The invention relates to a screening/sieving device. The device according to the invention may be used to separate bulk waste transported by a liquid. It is designed to be fitted into a channel of rectangular cross section, but its construction could be matched to other types of duct.

The common name for this type of device is “fine screen unit”.

The procedure and the device described are particularly intended for screening waste waters.

### PRIOR ART

There is a multitude of screening/sieving devices on the market. They use various types of filter screens through which the liquid is filtered. The use of the filter screen is also quite variable. Some devices do not have any kind of moving mechanism, while others are quite sophisticated from the mechanical standpoint. In the present description, it is virtually impossible to describe all the existing constructions and their specific features. The rough classification below only makes it possible to place the device according to the invention among the multitude of existing devices.

Existing devices may be roughly classed according to the following criteria (for the most common constructions):

Filtration Mesh:

The filtration mesh can vary from a few tens of microns (cloth sieve) to several centimetres (bar grids).

Types of Filter Screen:

The filter screen may be a woven cloth, a perforated metal sheet, a row of bars of varying closeness or a filter screen consisting of several different elements.

Construction and Implementation:

The device may be fitted into a channel (sieving with no pressure drop) or designed as an independent apparatus fed by gravity or by pumping. There are also devices which are mounted on closed pipework.

Cleaning Method:

The filter screen may be cleaned mechanically or else by pressure washing or else a combination of the two.

Method of Removing Waste:

The removal of waste is one of the key problems of this type of device. The problem is relatively easy to solve on “independent” apparatuses which may be fed by pumping or, more generally, placed high up in order to allow the waste to be recovered by gravity to a lower level. However, it becomes more difficult when devices fitted inside a channel are involved. In this case, waste is most often removed in one of the following ways:

the filter screen is cleaned by an Archimedes screw or a feed screw, which takes the waste upwards and optionally compacts it at the same time. In this case, the screw must rise at a certain angle with respect to the horizontal (it is virtually never vertical). This considerably extends the screw and limits the use of this type of device to shallow channels, in general less than three metres.

the filter screen takes the waste upwards by successive movements of some parts of the screen (such as the “step screen”). In this case also the device is steeply inclined, which limits the depth of the channel in which this type of device can be fitted.

the filter screen with waste attached thereon rises, the waste is separated, after which the said screen goes back down into the channel. More often than not, a filter screen designed as a conveyer belt is involved. The part loaded with waste rises and its place in the liquid is taken by another “clean” part, which ensures that the filtration is continued while the part of the filter screen loaded with waste is cleaned. The major drawback of this type of device is the risk of “losing” waste which is not separated from the filter screen and which again returns to the liquid downstream of the device.

the waste is picked up in the low part of the filter screen by a “rake” located on the upstream side of the screen. This rake makes it slide upwards in order to separate it from the screen. This technique is sometimes used for perforated filter screens but in the great majority of cases, bar filter screens are involved. Thus waste is retained on the bars and the liquid flows between the bars. At the time of cleaning, the teeth of the rake enter between the bars on the upstream side of the screen unit towards the bottom of the channel. Once at the top, the teeth come out from the row of bars in order to deposit the waste and prevent the waste from going back down into the channel when the rake next descends. This type of grid is fairly widespread and has several advantages. The construction is simple and robust and the filter screen may be practically vertical. It is therefore easy to use for deep channels without the construction of the device becoming too heavy and without occupying excessive space along the channel. The major drawback of this type of screen unit is the size of the filtration mesh which remains relatively high—rarely less than ten mm. The problem is a mechanical one. On the one hand, in the upper part, the teeth of the rake must come out of the slots formed by the bars of the filter screen, go back down along the screen and re-enter between the bars in the low part, that is to say generally several metres lower. On the other hand, the conditions of use are often testing for the equipment. Consequently, it is difficult to maintain, over time, a degree of accuracy enough to allow a filtration mesh which is too fine and less than the said ten mm. This is because decreasing the distance between the bars of the filter screen would lead to problems of guiding the rake and friction when the claws enter between the bars, and hence a decrease in the reliability and the robustness of the equipment.

### BRIEF DESCRIPTION OF THE INVENTION

The device according to the invention is of the same type as the last device described above. However, the original design of the filter screen and of the cleaning rake make it possible to prevent mechanical problems and to considerably decrease the size of the filtration mesh.

The screen unit comprises a filter screen consisting of bars stretched between two supports and a cleaning rake located downstream of the screen. To clean the filter screen, this rake slides along the said screen in order to push the waste upwards. Once at the top, the teeth of the rake move forwards without coming back out of the screen in order to deposit the waste onto a fixed “comb” located on the upstream side of the filter screen. Once the waste is deposited onto the comb, the teeth of the rake move back and enter between the bars of the screen (without however coming back out thereof), sliding along the screen to the bottom of the channel and going back into standby position for a new cleaning cycle.

The way in which the invention may be embodied and the advantages resulting therefrom will become more apparent from the following exemplary embodiments, given by way of non-limiting indication, with the support of the appended figures.

### BRIEF DESCRIPTION OF THE FIGURES

FIG. 1 is a schematic representation of the device according to the invention, seen from the front.

FIG. 2 is a schematic representation, in horizontal section made through the filter screen and its support frame, of the device of the invention.

FIG. 3 is a schematic representation, in horizontal section, of the device of the invention with the cleaning rake, its support and its guide system and the comb for cleaning the rake, the cleaning rake being in the “stop” position.

FIG. 4 is a schematic representation in horizontal section similar to FIG. 3, but with the cleaning rake in the forward position and the waste deposited on the cleaning comb.

FIG. 5 is a schematic representation in vertical section of the device according to the invention, the cleaning rake being in the “stop” position.

FIG. 6 is a schematic representation in vertical section similar to FIG. 5, the cleaning rake having taken the waste up to the high position.

FIG. 7 is a schematic representation in vertical section similar to FIG. 5, the cleaning rake depositing the waste onto the cleaning comb.

FIG. 8 is a schematic representation in vertical section similar to FIG. 5, after the waste is deposited by the cleaning rake onto the cleaning comb.

FIG. 9 is a schematic representation in vertical section similar to FIG. 5, the cleaning rake being moved back with the teeth inside the row of bars of the filter screen and going back down to the low position.

FIG. 10 is a schematic representation in vertical section similar to FIG. 5, the cleaning rake being in the low position, the teeth still being moved back inside the row of bars of the filter screen, just before the rake moves forwards to return to the position shown in FIG. 5.

FIGS. 11 to 16 illustrate a variant of the device according to the invention. The sequences are the same as those shown with respect to FIGS. 5 to 10.

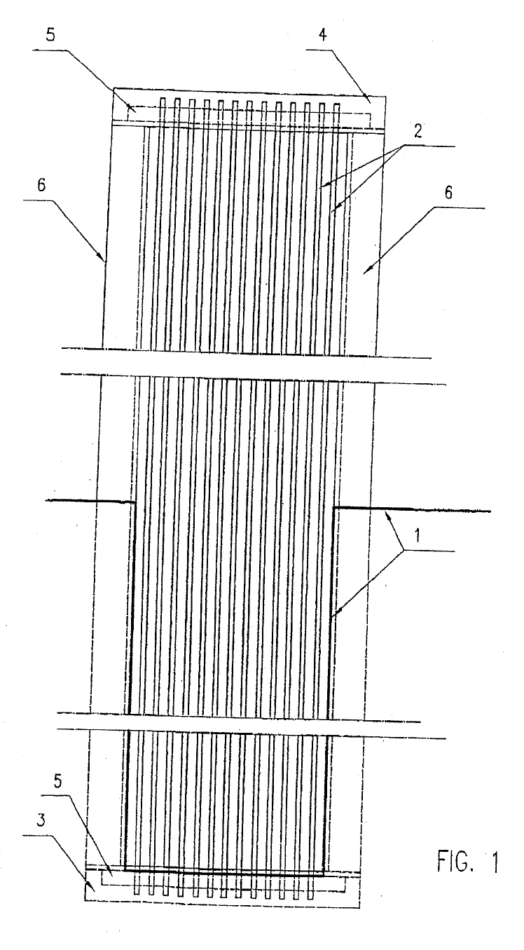

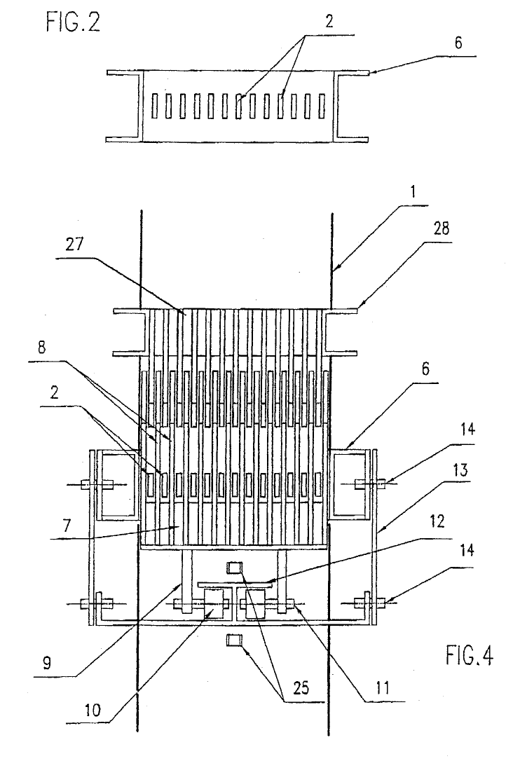

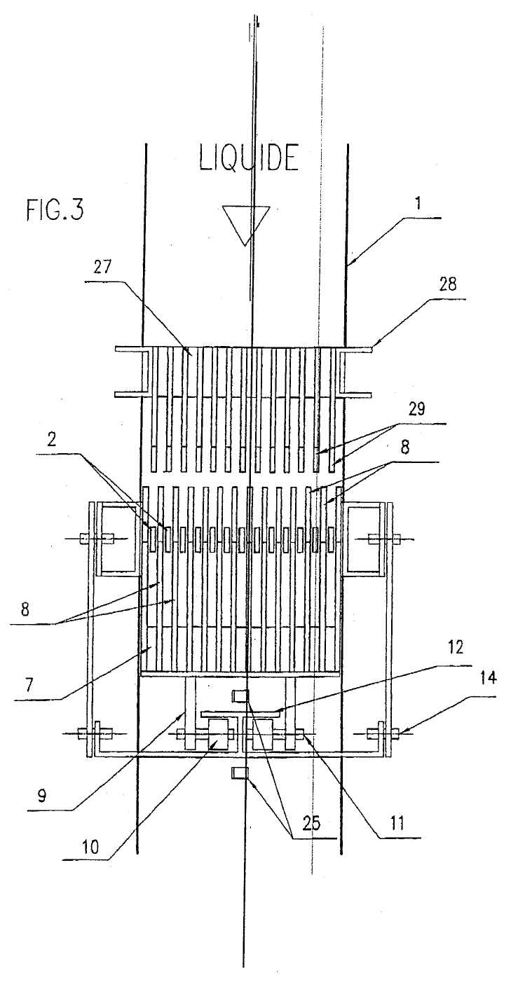

### DETAILED DESCRIPTION OF THE DEVICE ACCORDING TO THE INVENTION

The device according to the invention (hereinafter called “the screen unit”) is designed to be fitted into a channel (1) at the bottom of which flows the liquid transporting the bulk material (the waste to be removed).

According to a first feature of the invention, the screen unit comprises a filter screen consisting of bars (2) arranged in a row at some distance from each other. The bars (2) are stretched between two beams (3) and (4). The beam (3) is fastened to the bottom of the channel (1). The beam (4) is located above the channel (1) substantially vertically above the beam (3). The two beams (3, 4) are connected by posts (6) so as to form a frame. Each of the bars (2) passes through each of the beams (3, 4) via slots cut in each beam (detail not shown) and are locked by locking bars (5). The stiffness of the frame formed by the beams (3, 4) and the posts (6) makes it possible to stretch the bars (2) so that they remain perfectly straight.

The cleaning rake (7) of the filter screen is located behind the said screen, on the downstream side with respect to the direction of liquid flow. The teeth (8) of the rake (7) are oriented against the direction of liquid flow and have a thickness less than the distance separating the bars (2). They are arranged so that each claw or tooth is positioned facing a slot defined by two adjacent bars. Thus the teeth (8) of the rake enter between the bars (2) and can slide along the filter screen while still remaining between the bars. In the “stop” position, the end of the teeth or claws (8) goes beyond the row of bars (2) for some distance towards the downstream side of the filter screen.

The cleaning rake (7) is fastened to a carriage (9), equipped with rollers (10) connected to the carriage via spindles (11). Thus the carriage (9) can slide along a rail (12). For its part, the rail (12) is connected to the posts (6) via arms (13) and spindles (14). These arms (13) and spindles (14) allow the rail (12) to come close to or move away from the filter screen while remaining parallel to the said screen. This movement of the rail (12) is provided by a gear motor (15). The latter is mounted on a support (16) and is connected to the rail (12) via a pinion (17), a chain (18) and an arm (19). The weight of the rail/carriage assembly is balanced by the counterweight (20). Thus the distance between the rail (12) and the filter screen may be controlled by the position of the counterweight via proximity detectors (21).

The carriage (9) slides along the rail (12) by means of a gear motor (22), actuating a chain (25) secured to the said carriage (9) and engaging on pinions (23) and (24). Another proximity detector (26), which counts the rotations of the pinion (23), allows the position of the carriage (9) on the said rail to be monitored.

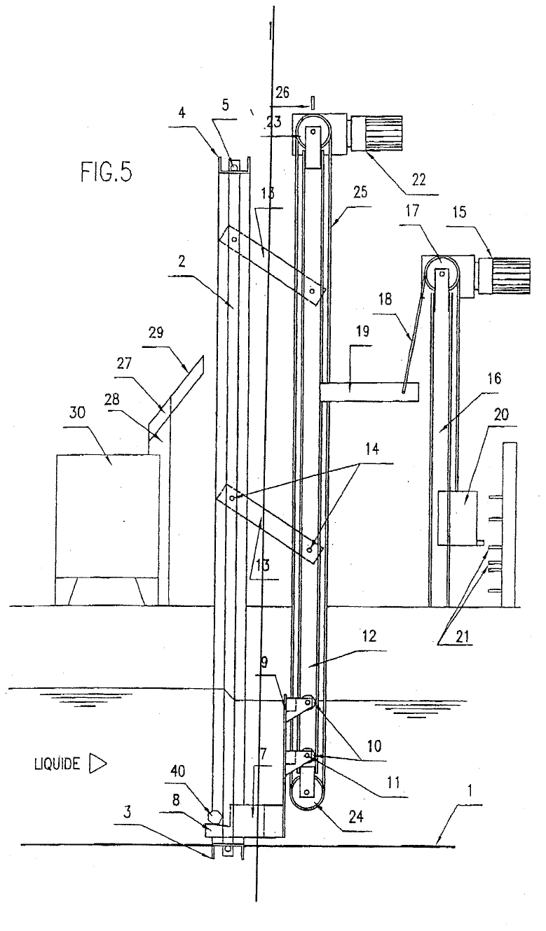

The comb (27) for cleaning the rake (7) is fastened to a support (28) located above the channel (1) on the upstream side of the filter screen with respect to the direction of liquid flow. The cleaning comb (27) generally has the same construction as the rake (7). Each of its teeth (29) is facing a bar (2) and has the same thickness as the said bar. In this way, the teeth (8) of the rake (7) may enter between the teeth (29) of the comb (27) as shown in FIG. 4.

The device according to the invention operates as follows:

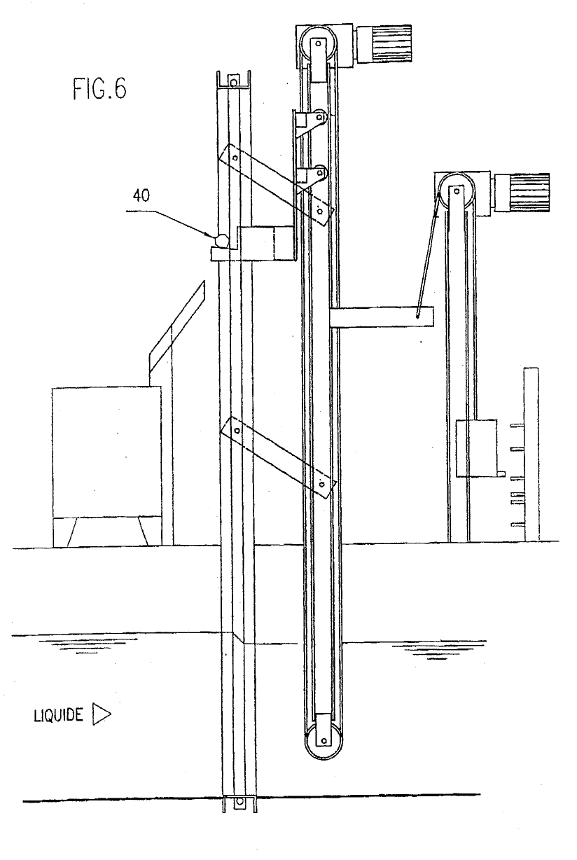

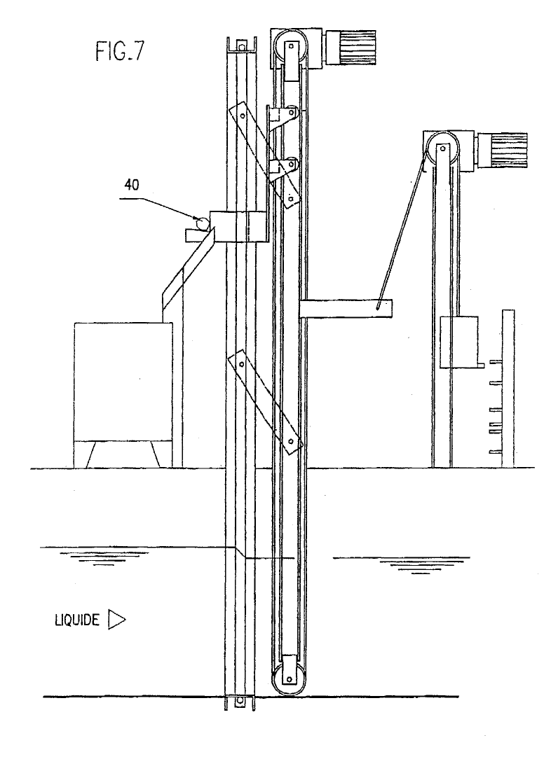

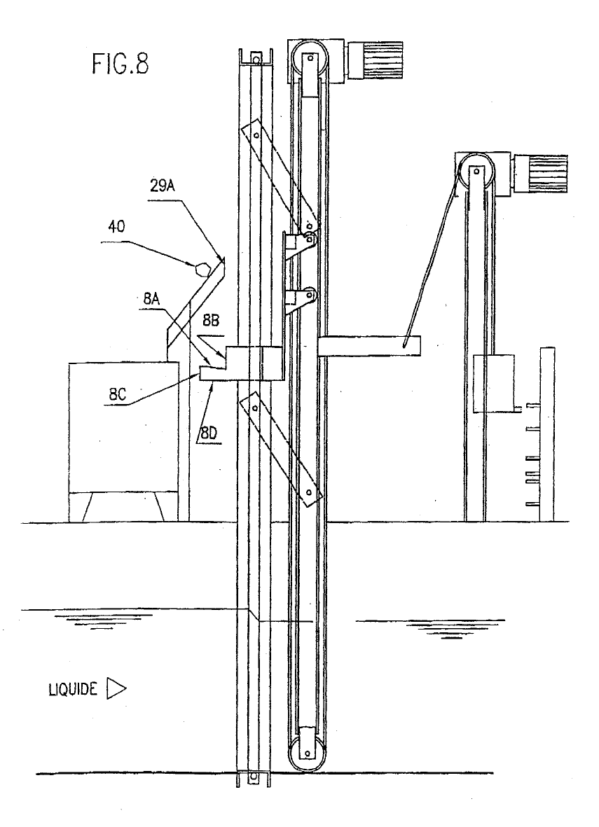

In the “stop” position (FIG. 5), the carriage (9) is in the low position and the teeth (8) of the rake (7) go beyond the filter screen towards the upstream side. When the screen needs to be cleaned, the gear motor (22) is actuated and makes the carriage (9) (and therefore the rake (7)) slide along the filter screen. The upper horizontal part of the teeth (8A) (see FIG. 8) thus rises between the bars (2) and takes the bulk matter (40) (hereinafter called waste) retained on the filter screen up with it. In the “high” position of the carriage (9) (FIG. 6), when the rake (7) is above the cleaning comb (27), the gear motor (22) stops. Next, via the gear motor (15), the rail (12) is lowered so that the teeth (8) of the rake (7) move forwards towards the upstream side of the filter screen until the vertical part (8B) of the said teeth go beyond the end (29A) of the teeth (29) of the cleaning comb (27). Thus, the waste (40), carried by the corner formed by the parts (8A) and (8B) of the teeth (8), are above the teeth (29) of the cleaning comb (27), as shown in FIG. 7. The gear motor (15) then stops and the gear motor (22) starts up in the reverse direction to make the rake (7) descend. The teeth (8) of the rake (7) cross over with the teeth (29) of the comb (27) and the waste (40) is deposited onto the said cleaning comb as shown in FIG. 8.

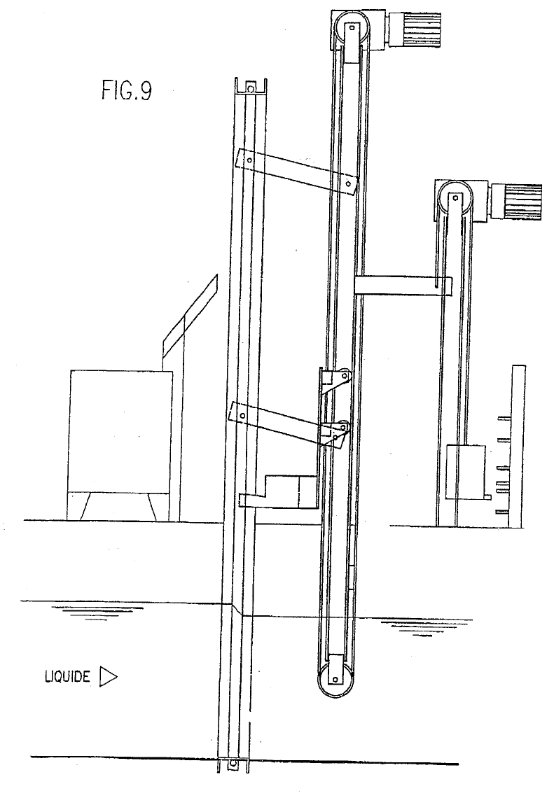

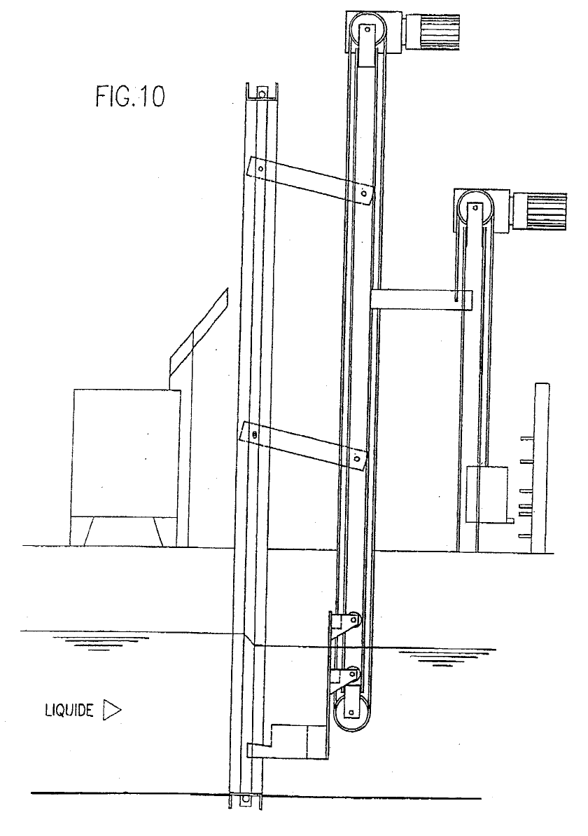

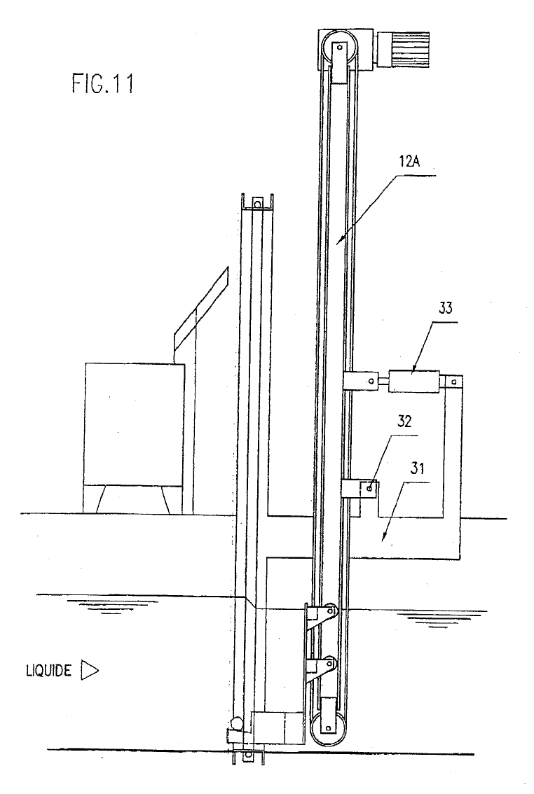

Once the waste is deposited on the cleaning comb, the rail (12) is raised by the gear motor (15), so that the end (8C) of the teeth (8) is between the bars (2) of the filter screen, as shown in FIG. 9. This position of the rail (12) is maintained until the carriage (9) descends to the low position as shown in FIG. 10. This makes it possible to prevent the waste being dragged (by the lower part (8D) of the teeth) downwards, which waste might have stopped on the filter screen in the meantime. The gear motor (22) is then stopped and the rail (12) is returned to the starting position shown in FIG. 5, by means of the gear motor (15).

As shown in FIGS. 5 to 10, the upper part of the teeth (29) is inclined. This makes it possible for the lower part (8D) of the teeth (8) of the rake (7) to push the waste deposited onto the cleaning comb during the previous cycle towards a skip. Thus, on descending between the teeth (29), the rake (7) fulfils two functions; it deposits the waste from the current cleaning cycle onto the comb (27) and, at the same time, it pushes the waste deposited during the previous cleaning cycle towards the skip (30).

The device according to the invention may be produced in several ways. First of all, the filter screen may be vertical or inclined with respect to the horizontal.

The bars (2) may be connected to the beams (3, 4) by any other means. Thus, each bar may be welded to the beam or be stretched via a threaded rod welded to the bar and a bolt.

The bars of the filter screen may be stretched between two beams connected by means of posts or fastened independently. The bars (2) may be made of metal, plastic or another material. They may have a rectangular, circular or other cross section.

The rake (7) and the cleaning comb (27) may also be made of metal, plastic or else comprise various elements made from different materials.

The device according to the invention may be equipped not only with a single rail (12), but with several rails for guiding the carriage (9) (for very wide screen units). Also, the rail for guiding the carriage (9) may be replaced by another mechanism which is not necessarily located “behind” the filter screen, on the downstream side with respect to the direction of liquid flow.

The rake can be slid between the bars (2) of the filter screen by a means other than a gear motor (22) and a chain (25). Thus it may be achieved by one or more racks, by one or more threaded rods or else by another means making it possible to move the rake along the filter screen.

The movements of the rail (12), and more generally the forward and backward movement of the rake (7) with respect to the filter screen, may be achieved by a means other than the gear motor (15) and the chain (18). This function may be fulfilled by a cylinder, by a rack, by a threaded rod or else by another mechanism for guiding the rail making it possible to obtain the path of the rake (7) as described. Thus the guide rail may remain immobile—in this case the rake (7) may be fastened to another mechanism allowing it to come close to or move away from the filter screen.

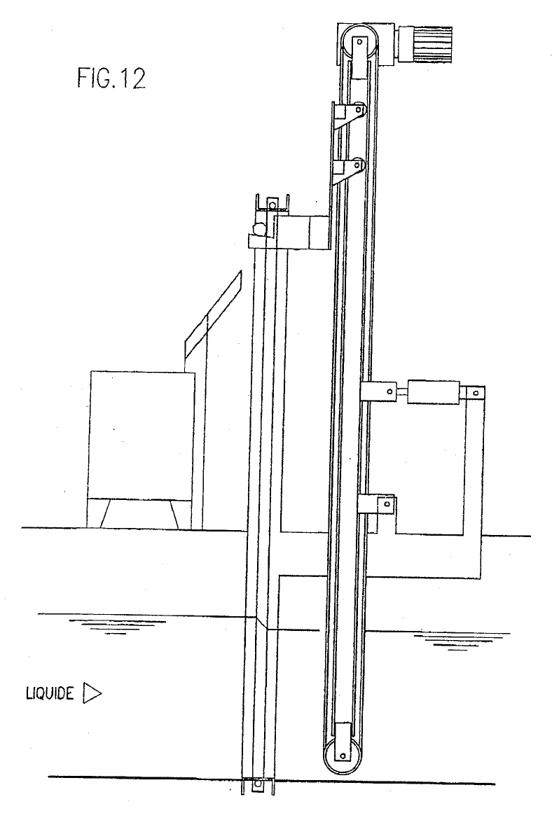

Also in the “stop” position, the rake (7) may remain in the intermediate position between the cleaning comb and the liquid surface. Thus, it will descend to the bottom of the filter screen and return to the position shown in FIG. 5 (or in FIG. 11) only when the new cycle for cleaning the filter screen is begun.

Finally, when cleaning the filter screen of the device according to the invention, the rake (7) may be guided not only by detecting the position of the various elements (proximity detectors, revolution counters, etc.) and by independent action on both means for moving the rake (7) and the rail (12). It is possible to have a single motor combined with a mechanical guiding device making it possible to overcome the second movement means.

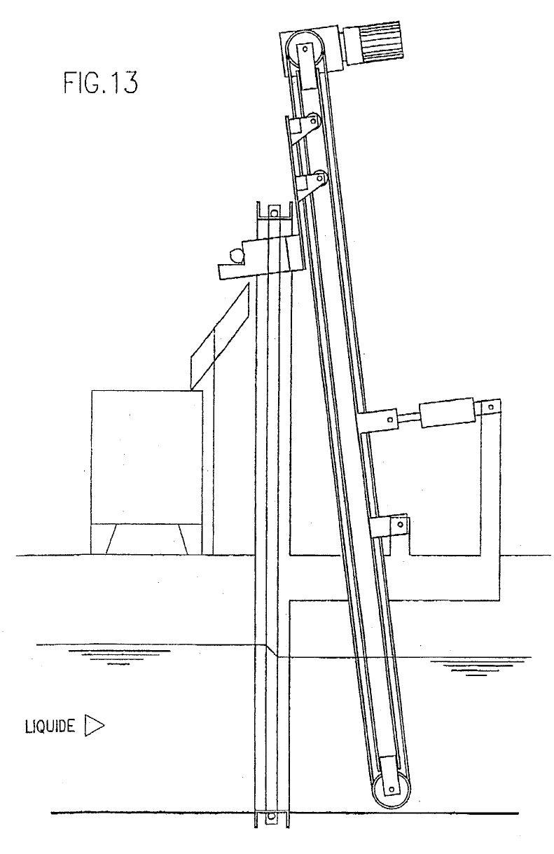

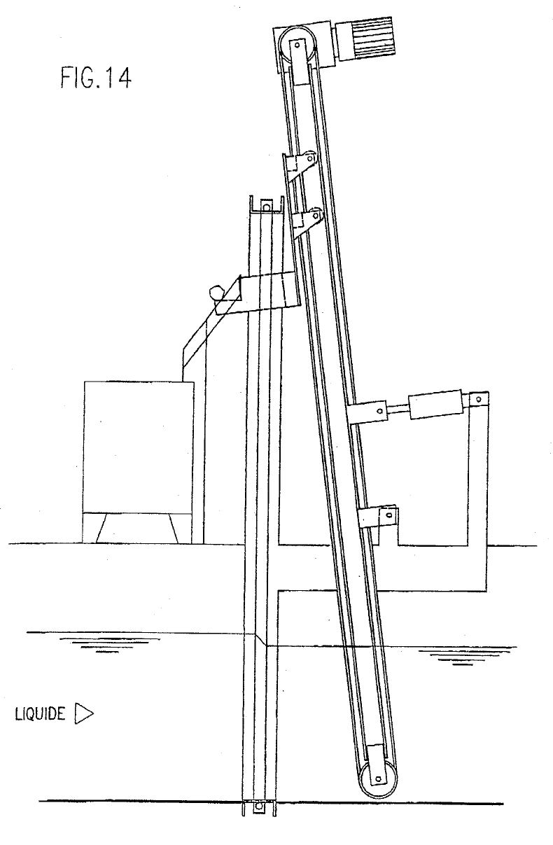

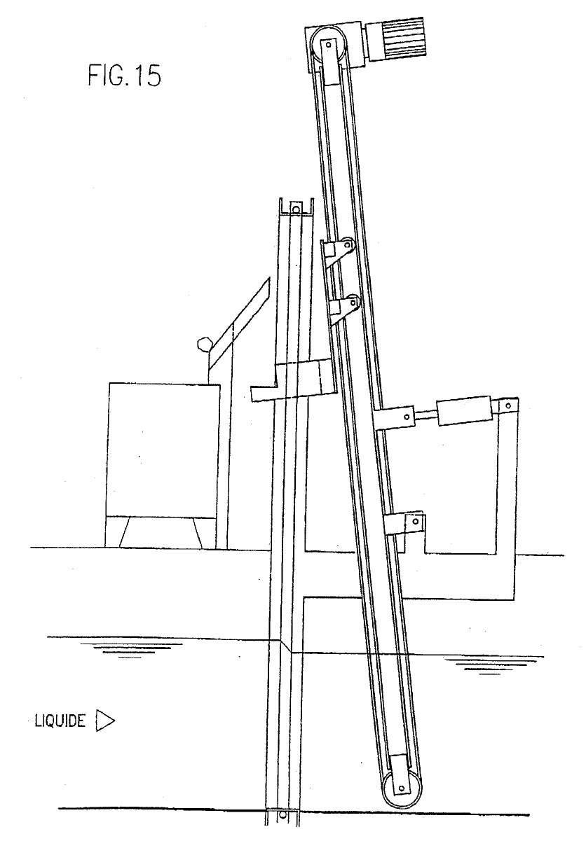

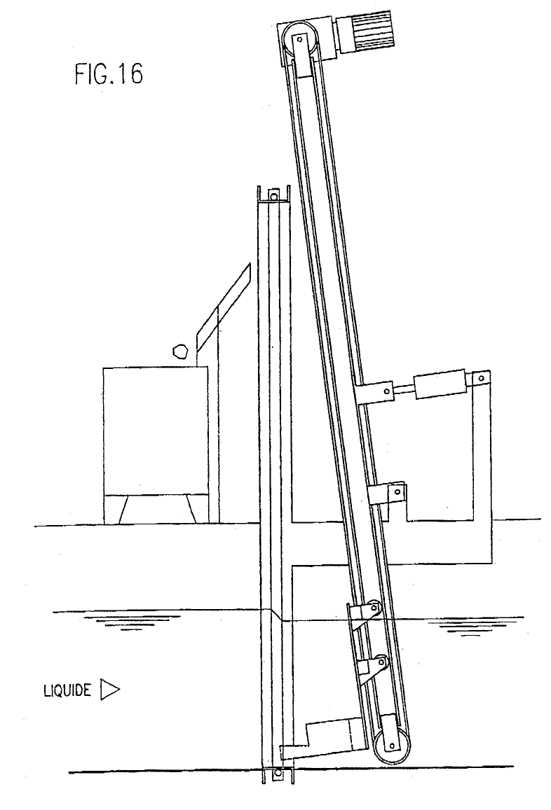

A variant of the device according to the invention is illustrated in FIGS. 11 to 16. In this variant, the rail for guiding the carriage is not held by the arms (13), but rests on a fixed support (31) (in this example, this support (31) is connected to the frame of the filter screen, but it is quite possible for the said support (31) to be fastened independently to the edges of the channel). The rail (12A) does not remain parallel to the filter screen as in the case described above, but pivots about an axis (32), which is horizontal and perpendicular to the direction of liquid movement. The assembly is moved by a cylinder (33), which makes it possible to incline the rail (12A) in order to bring the rake closer to the filter screen or move it away therefrom, when the said rake is in the low part or in the high part of the filter screen. The path of this cleaning rake with respect to the filter screen remains overall the same. The various operating sequences of this variant of the device according to the invention are shown in FIGS. 11 to 16 which repeat the same steps as those shown in FIGS. 5 to 10 respectively.

The principle of operation of this variant of the device according to the invention therefore remains the same. The waste stopped by the filter screen is recovered by the rake, taken up to the top of the channel and deposited onto the cleaning comb. Next, the rake returns to its initial position at the bottom of the filter screen. All these functions are carried out without the teeth of the rake leaving the slots of the filter screen. On the contrary, the cleaning rake is naturally guided by the bars of the filter screen throughout its path. The only “adjustment” of the device consists in placing the teeth (29) of the cleaning comb directly facing the bars of the filter screen, which is not difficult since the two elements are fixed.

By way of example, the dimensions of the screen unit described in connection with FIGS. 5 to 10 and 11 to 16 respectively may be of the following order of magnitude:

| | | |
|---|---|---|
| channel width: | 1 | m |
| channel depth: | 1.5 | m |
| total height of the screen unit: | 3 | m |
| distance between the bars of the | 5 | mm |
| filter screen: | | |

As a result, the full extent of the benefit of the device according to the invention within the context of sieving/screening liquid effluent and waste water is understood. Specifically, apart from a simplicity of construction, it can be easily installed in a very deep channel and offers the possibility of considerably reducing the size of the filter mesh thereby overcoming the mechanical problems.

1. Device for screening/sieving liquid transporting bulk material (40) within a channel (1), characterized in that it comprises:
a filter screen consisting of at least two bars (2) stretched between two beams (3, 4), placed at some distance from each other and extending beyond the height of the channel (1);
a movable cleaning rake (7) located behind the filter screen, on the downstream side with respect to the direction of liquid flow within the said channel, the said rake (7) being provided with teeth (8) intended to enter between the bars (2) of the filter screen and oriented in the direction in which the liquid arrives;
at least one guide rail (12), on which the cleaning rake (7) moves along the filter screen;
a cleaning comb (27) for the rake (7), mounted in a fixed manner and located in front of the filter screen, on the upstream side with respect to the direction of liquid flow, the teeth (29) of the said comb (27) being placed facing the bars (2) of the filter screen and oriented in the direction in which the liquid flows, it being possible for each of the teeth (8) of the said rake to enter the space defined between the teeth (29) of the said comb (27);
movement means making it possible, on the one hand, to move the rake (7) along the bars (2) of the filter screen, and on the other hand, to vary the position of the said rake (7) with respect to the surface of the filter screen so that the teeth (8) of the rake can enter between the bars (2) of the filter screen to some degree.

2. Liquid screening/sieving device according to claim 1, characterized in that the rake (7) moves along the bars (2) of the filter screen on at least the said guide rail (12), the said rail being equipped with guiding and movement means enabling it to remain parallel to the filter screen while coming close to or moving away from the said screen so that the teeth (8) of the said rake enter between the bars (2) to some degree.

3. Liquid screening/sieving device according to claim 1, characterized in that the rake (7) moves along the bars (2) of the filter screen on at least the said guide rail (12), the said rail being equipped with support and movement means and pivoting about a spindle (32), perpendicular to the direction of liquid movement, so as to allow the ends of the said rail (12) to come close to or move away from the filter screen and, consequently, to allow the rake (7) to come close to or move away from said screen so that the teeth (8) of the said rake enter between the bars (2) to some degree.

4. Liquid screening/sieving device according to one of claims 1 to 3, characterized in that the filter screen is oriented vertically.

5. Liquid screening/sieving device according to one of claims 1 to 3, characterized in that the filter screen is inclined with respect to the horizontal.

6. Liquid screening/sieving device according to one of claims 1 to 5, characterized in that the bars (2) of the filter screen have a cross section which is rectangular, circular or any other geometrical shape.

7. Liquid screening/sieving device according to one of claims 1 to 6, characterized in that the bars (2) of the filter screen are made of metal, plastic or any other material.

8. Liquid screening/sieving device according to one of claims 1 to 7, characterized in that the rake (7) and the cleaning comb (27) are made of metal, plastic or any other material or else comprise several different elements made from different material.

9. Liquid screening/sieving device according to one of claims 1 to 8, characterized in that it comprises a single movement means making the rake (7) slide along the bars (2), the said means being combined with a mechanical device also making it possible, depending on the position of the rake, to bring the said rake close to or away from the filter screen so that the teeth (8) of the said rake enter between the bars (2) to some degree.

10. Procedure for screening and sieving a liquid transporting bulk material (40) flowing within a channel (1), consisting in positioning, within the said channel, a screening/sieving device incorporating a filter screen oriented substantially perpendicularly to the direction of liquid flow within the channel, the said device comprising:
a filter screen consisting of at least two bars (2) stretched between two beams (3, 4) and placed at some distance from each other, and extending beyond the height of the channel;
a movable rake (7) fitted with teeth (8), designed to enter between the bars (2) of the filter screen;
a comb (27) for cleaning the rake (7), in front of the filter screen, the teeth (29) of the said comb being placed facing the bars (2) of the filter screen, it being possible for each of the teeth (8) of the said rake to enter the space defined between the teeth (29) of the said comb (27);
movement means making it possible, on the one hand, to move the rake (7) along the bars (2) of the filter screen, and on the other hand, to vary the position of the said rake (7) with respect to the surface of the filter screen so that the teeth (8) of the rake can enter between the bars (2) of the filter screen to some degree;
characterized in that it consists:
while cleaning the filter screen, in making the rake (7) slide along the bars (2) defining the filter screen from the bottom upwards, the teeth (8) of the said rake going beyond the surface of the said screen on the upstream side with respect to the direction of liquid flow at enough distance to make it possible to retain and drag the bulk material retained on the screen;
then, when the said rake has arrived at the top of its rising travel, therefore being above the cleaning comb (27), in moving the rake forwards in the direction of the said comb (27) and then in moving the rake back down so that the teeth (8) of the rake (7) enter between the teeth (29) of the said comb (27), the bulk material being transferred from the rake (7) to the comb (27);
after depositing the bulk material onto the comb (27) and as it descends to the bottom of the filter screen, in positioning the rake (7) so as to be moved back with respect to the upstream surface of the said screen and so that the end (8C) of the teeth (8) is between the bars (2) of the screen.
